(19) United States
(12) Patent Application Publication
(10) Pub. No.: US 2005/0248466 A1
(43) Pub. Date: Nov. 10, 2005

(54) Safety door system

(76) Inventors: John Ghazarian, Henderson, NV (US); Daniel Joseph Cote, Henderson, NV (US)

Correspondence Address: John Ghazarian, 530 Startop Street, Henderson, NV, 89052, US

(21) Appl. No.: 10/669,336

(22) Filed: Sep. 22, 2003

Related U.S. Application Data
(60) Provisional application No. 60/413,045, filed on Sep. 23, 2002.

(51) Int. Cl. G08B 21/00

(52) U.S. Cl. 340/686.1; 340/545.1

(57) ABSTRACT

Safety door system comprises of door edge and doorframe mount conductive material, which is connected to an electronic control circuitry equipped with an audio or visual warning alarm devise. The system is designed during door closure to detect human body limb (Fingers, hands) touching the door edge or door inner frame, and alert the person tempting to close the door, to the presence of human body limb between the door and doorframe, by an audio or visual alarm signal. During a door closure, if a human body limb touches the door edge or door inner frame mount conductive material. The electronic control circuitry detects the presence of human body touch, and transmits an audio or visual warning alarm, to avoid the users or other person(s) hand or finger(s) getting caught in between door and doorframe. In a preferred embodiment, the safety door system additionally is equipped with an electromechanical doorstopper, which is connected to an electronic control circuitry. During a door closure, when a person touches the door mount conductive material, the electronic circuitry upon detecting human body touch detection signal, the electronic circuitry transmits a signal into electromechanical door stopper to stop the door from closing.

### BACKGROUND OF THE INVENTION

The present invention relates to systems and methods for avoiding and or stopping accidental doors closures on human body limb, such as hands or fingers. And more particularly to an improved system and method which operates automatically, during a door closure when human body touches a door edge or doorframe inner edge.

A number of different methods have been used in the past to deal with the problem of stopping human hands getting caught in doors during door closures. One such known system is the use of a Door stopper, which is made of a wood, plastic or metal material mounted on door edge or doorframe, to stops a door from completely closing, thus living the door not shut completely. Ultimately, this system will not allow user to close a door, or lock a door, and does not provide any means of security, and not able to prevent intruders walking inn through a door.

It is further objective of the safety door system of the present invention that it is capable of automatically detecting human body touch on a door edge or doorframe inner edge, and prevent accidental door closure by user, on human hands or Fingers, by producing warning audio and or visual alarm signal.

It is further objective of the safety door system of the present invention that is capable of automatically detecting human body limb touch on a door edge or a doorframe inner edge, and stop a door from closure when human body touch is detected on a door edge or a doorframe inner edge, by use of an electromechanical door stopper.

It is further objective of the present invention that provides safety and security, allowing user to safely close a door, or lock a door without the possibility of user or others hands or fingers getting caught in a door during door closure, and prevent intruders walking through a door.

### SUMMARY OF THE INVENTION

Accidental door closure cause human physical injury, such known occurrences takes place when individuals leave there arm, hand, fingers etc. inside doors during process of closing a door, initiated to themselves and or in particularly by others. Such common occurrence takes place during closing of a house, office or a vehicle door. Etc.

It is according to the present invention, which is designed to avoid such unnecessary injuries, by the use of safety door sensing mechanism system, to avoid individuals from getting physically injured during a door closure.

Safety door system comprises of, a door edge mount and door inner frame mount conductive material, the material is capable of sensing human body touch. A electronic control unit powered by a power supply is connected to an audio and or visual warning alarm devise, and the electronic control unit is connected to the door conductive material.

During a door closing process, when a persons hand or fingers touches the door edge or door inner frame mount conductive material, the conductive material will sense human touch, and sends a signal to the electronic control unit, which upon receipt of the signal energies the audio and or visual alarm devise to warn the person closing the door to take away there hands, finger(s), or body limb from the door edge or door inner frame, to avoid hand(s) or fingers from being caught between the door and the door frame.

In a preferred embodiment of the invention, the safety door system additionally comprises of, an electronic control unit connected to an electromechanical door actuator having multi-position door closure stopping mechanism.

During a door closing process, when a person hand or fingers touch the door edge or door inner frame mount conductive material, the electronic control unit detects the human body touch signal, and energies the electromechanical actuator which stops the door from closing. When the person removes their hands or stops making body contact with the door edge or door inner frame, the electronic control unit releases the door actuator mechanism. Allowing the person closing the door to close the door without user or other person hand or finger(s) caught in between doorframe and the door.

### BRIEF DESCRIPTION OF THE DRAWINGS

FIG. 1 Is a Safety Door System, wherein illustrates a vehicle door frame, and vehicle Door being equipped with door insulation material made of conductive material.

FIG. 2 Is a Safety Door System, wherein illustrates a door equipped with conductive material, utilizing an Electromechanical doorstopper with a warning audio/visual Alarm devise.

FIG. 3 Illustrates an Electromechanical Door Stopper with multi position door closure stopping shaft.

FIG. 4 Illustrates inner top view of a vehicle door equipped with an actuator and a multi-position door closure-stopping shaft

FIG. 5 Is general block diagram of Safety Door System.

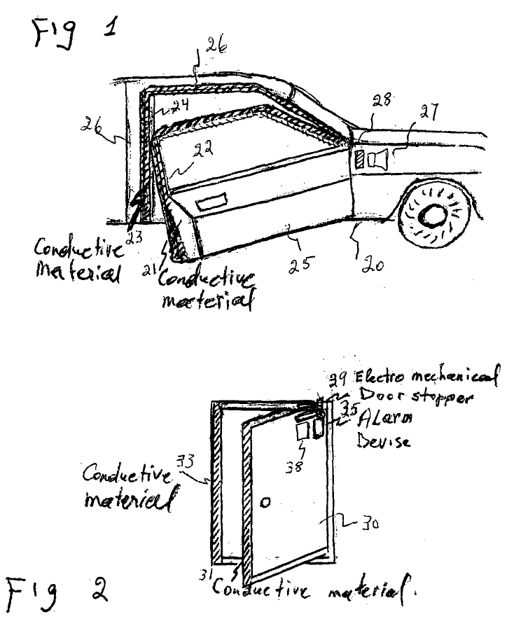

### DETAILED DESCRIPTION OF THE INVENTION

The preferred embodiment of Safety Door System is illustrated in the Fig, I wherein a vehicle 20 having a door frame 26, and a door 25 both door frame and door edge having equipped with conductive material 21, 22 and 23, 24 example; as a door insulation rubber, installed one in the inner mount of the vehicle door frame 26, consist of two separate layers of conductive rubber 23 and 24 running parallel across the vehicle door frame edge 26, another set is installed on vehicle door inner edge 21 and 22. Instead of two separate layers, a single layer conductive rubber may be utilized through the vehicle doorframe 23 or vehicle door inner edge 21.

Both vehicle door frame 23, 24 or vehicle door mount conductive material 21, 22 is connected to an electronic control circuitry 28 connected to an audio/visual alarm devise 27. The system is designed during vehicle door 25 closure detect human body touch across vehicle doorframe 23, 24 opening and vehicle door edge 21, 22.

During door closure of the vehicle 20 equipped with Safety Door System, if a person or a child have their hand, fingers touching the inner edge side of a vehicle doorframe 23, 24 or vehicle door 21, 22, two paralleled positioned conductive material, causes a loop signal in the electronic control circuitry 28. (If single layer of conductive material 21, 23 is used it creates a detection signal within the electronic control circuitry). The electronic control circuitry upon receiving of the signal, generates an audio/visual alarm 27 to worn the person closing the vehicle door 25 to the presence of human hand or finger(s) in the inner section of said vehicle 20 doorframe 26 or door 25.

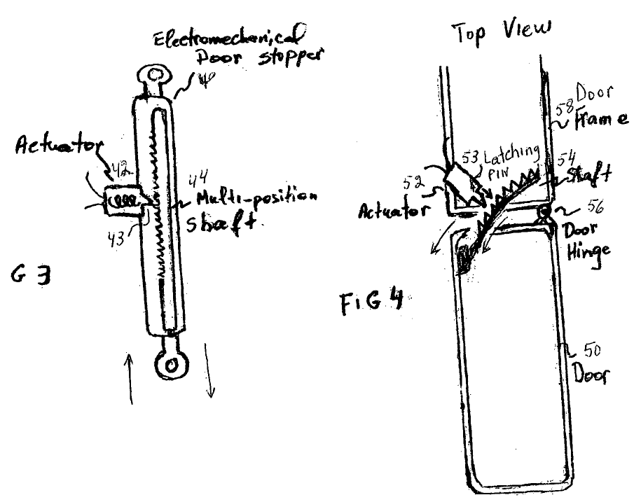

As illustrated in FIG. 2 wherein a door 30 is equipped with conductive material on inner doorframe edge 33 and on door edge 31. Both door frame and door edge mount conductive materials 31 and 33 is connected to an electronic control circuitry 38, which controls both the operation of electromechanical door stopper 39, and audio/visual alarm devise 35.

During door 30 closure, if a person or a child touches the doorframe inner edge or door edge mount conductive material 31, 33, the electronic circuitry detects the presence of human hand or finger, and signals to electromechanical door stopper 39 to automatically stop the door 30 from closure, and additionally may send a signal to audio/visual alarm device to activate the audio/visual alarm 35.

As Illustrated in FIG. 3, which gives detailed description of a door mount Electromechanical door stopper 40 used in the present art, wherein a multi position treaded shaft 44 is used in an electromechanical door stopper cylinder 40, the shafts 44 movement normally with door opening or door closure is free. The actuator 42 controls the free movement of the shaft. The actuator 42 stops the shaft 44 movements, only upon receipt of a signal from an electronic control circuitry, by pushing forward the actuator pin 43 towards the shaft 44, which immobilizes shaft 44 movements.

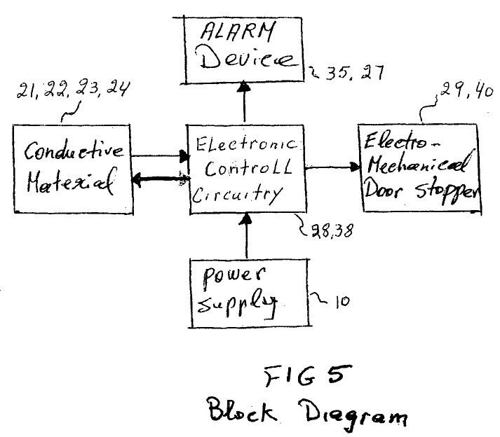

As Illustrated In FIG. 4, wherein described a doorframe 58 equipped with an actuator 52, and a door 50 equipped with a door closure control shaft 54. The door 50 is mounted on doorframe 58 by use of a hinge 56.

When the electronic circuitry receive human touch detection signal from door frame or door mount conductive material, the electronic control unit transmits a signal to door frame mount actuator 52, which upon receipt of the signal pushed forward the actuator latching pin 53 to lock the movement of the door mount shaft 54.

1-10. (canceled)

11. A knee brace for supporting a knee joint, said knee brace having a substantially rigid upper member for attachment to a thigh, a substantially rigid lower member for attachment to a calf, and first and second hinges located about an axis of said knee joint for connecting said upper and lower members together, said upper member comprising:
a substantially straight upper lateral segment having a top end and a bottom end, said upper lateral segment extending vertically along a lateral portion of the thigh, said bottom end of said upper lateral segment being coupled to said first hinge;
a substantially straight upper medial segment having a top end and a bottom end, said upper medial segment extending vertically along a medial portion of the thigh, said bottom end of said upper medial segment being coupled to said second hinge, said upper medial segment being shorter in length than said upper lateral segment;
an upper curved segment extending horizontally around a front portion of the thigh, said upper curved segment having a lateral end and a medial end, said lateral end being joined to said top end of said upper lateral segment; and
an angled segment having an upper end joined to said medial end of said upper curved segment, said angled segment having a lower end joined to said upper end of said upper medial segment, said angled segment being configured for circumventing a medial superior region of the thigh; said lower member comprising:
a substantially straight lower lateral segment having a top end and a bottom end, said lower lateral segment extending vertically along a lateral portion of the calf, said top end of said lower lateral segment being coupled to said first hinge;
a substantially straight lower medial segment having a top end and a bottom end, said lower medial segment extending vertically along a medial portion of the calf, said top end of said lower medial segment being coupled to said second hinge; and
a lower curved segment extending around the calf from said bottom end of said lower lateral segment to said bottom end of said lower medial segment.

12. The knee brace of claim 11, wherein said first and second hinges are polycentric hinges.

13. The knee brace of claim 11, wherein said upper and lower members are each formed as a continuous rigid unit.

14. The knee brace of claim 11, wherein said angled segment and said upper curved segment intersect at an angle between about 30 degrees and 60 degrees.

15. The knee brace of claim 11, wherein said angled segment extends around the front portion of the thigh by about 40 degrees to 80 degrees.

16. The knee brace of claim 11, further comprising first and second straps for securing said upper member to the thigh, said first strap being substantially aligned with said upper curved segment.

17. The knee brace of claim 16, further comprising third and fourth straps, said fourth strap being substantially aligned with said lower curved segment.

18. The knee brace of claim 11, wherein no structure is provided along the thigh in the region below the upper curved segment and the angled segment.

19. The knee brace of claim 11, wherein said upper and lower members are each made of a durable plastic.

20. A knee brace for supporting a knee joint, said knee brace having a substantially rigid upper member for attachment to a thigh, a substantially rigid lower member for attachment to a calf, first and second hinges located about an axis of said knee joint for connecting said upper and lower members together, and at least a first strap for securing said upper member to the thigh, said upper member comprising:
a substantially straight upper lateral segment having a top end and a bottom end, said upper lateral segment extending vertically along a lateral portion of the thigh, said bottom end of said upper lateral segment being coupled to said first hinge;
a substantially straight upper medial segment having a top end and a bottom end, said upper medial segment extending vertically along a medial portion of the thigh, said bottom end of said upper medial segment being coupled to said second hinge, said upper medial segment being shorter in length than said upper lateral segment;
an upper curved segment extending horizontally around a front portion of the thigh, said upper curved segment having a lateral end and a medial end, said lateral end being joined to said top end of said upper lateral segment; and
an angled segment having an upper end joined to said medial end of said upper curved segment, said angled segment having a lower end joined to said upper end of said upper medial segment, said angled segment being configured for circumventing a medial superior region of the thigh;
wherein said first strap is substantially aligned with said upper curved segment.

21. A knee brace for supporting a knee joint, said knee brace having a substantially rigid upper member for attachment to a thigh, a substantially rigid lower member for attachment to a calf, and first and second hinges located about an axis of said knee joint for connecting said upper and lower members together, said upper member comprising:
a substantially straight upper lateral segment having a top end and a bottom end, said upper lateral segment extending vertically along a lateral portion of the thigh, said bottom end of said upper lateral segment being coupled to said first hinge;
a substantially straight upper medial segment having a top end and a bottom end, said upper medial segment extending vertically along a medial portion of the thigh, said bottom end of said upper medial segment being coupled to said second hinge, said upper medial segment being shorter in length than said upper lateral segment;
an upper curved segment extending horizontally around a front portion of the thigh, said upper curved segment having a lateral end and a medial end, said lateral end being joined to said top end of said upper lateral segment; and
an angled segment having an upper end joined to said medial end of said upper curved segment, said angled segment having a lower end joined to said upper end of said upper medial segment, said angled segment being configured for circumventing a medial superior region of the thigh;
wherein no rigid structure is provided along the thigh in the region directly below the upper curved segment and the angled segment.

22. A knee brace for supporting a knee joint, comprising:
an upper member for attachment to a thigh, said upper member including an upper lateral segment having a top end and a bottom end, an upper medial segment having a top end and a bottom end, said upper medial segment being short in length than said upper lateral segment, a contoured segment having an upper end joined to said top end of said lateral segment and a lower end joined to said top end of said medial segment, said contoured segment extending across a front portion of the thigh and substantially circumventing a medial superior region of the thigh;
a lower member for attachment to a calf including a lower lateral segment having a top end and a bottom end, a lower medial segment having a top end and a bottom end, and a lower curved segment extending around a back portion of the calf, said lower curved segment being joined to said bottom end of said lower lateral segment and said bottom end of said lower medial segment;
a first hinge for rotatably coupling said upper lateral segment to said lower lateral segment; and
a second hinge for rotatably coupling said upper medial segment to said lower medial segment.
